(19) United States
(12) Patent Application Publication
(10) Pub. No.: US 2005/0009414 A1
(43) Pub. Date: Jan. 13, 2005

(54) Contact element for an electrical plug connection

(76) Inventors: Harald Schorr, Stuttgart (DE); Peter Rehbein, Weissach (DE); Piet Van Dijk, Vh Sint-Michielsgestel (NL)

Correspondence Address: KENYON & KENYON, ONE BROADWAY, NEW YORK, NY, 10004, US

(21) Appl. No.: 10/486,254

(22) PCT Filed: Feb. 18, 2003
(86) PCT No.: PCT/DE03/00481

(30) Foreign Application Priority Data
Jun. 4, 2002 (DE) 202 08 635.6

(51) Int. Cl. H01R 11/22

(52) U.S. Cl. 439/857

(57) ABSTRACT

A contact element as part of a plug connector is described, which is mountable in a connector housing and provides a contact zone to establish an electrical connection, which may be disconnected again, with a mating connector having at least one blade. The contact zone has at least two contact parts that are positioned at a distance from each other and are provided to receive the blade, each contact part having two contact points.

### FIELD OF THE INVENTION

The present invention relates to a contact element as part of a plug connector, which is mountable in a connector housing and provides a contact zone to establish an electrical connection, which may be disconnected again, with a mating connector having at least one contact blade.

### BACKGROUND INFORMATION

Electrical plug-and-socket connections are provided in order to establish a connection between a socket part and a plug part, the socket part usually having contacts that are received by pins, blades, or the like which are located in the mating connector, so that electrical contact may be established between the plug connector and the mating connector. This electrical plug-and-socket connection may be disconnected again.

To establish the electrical plug-and-socket connection, the blade located in the mating connector penetrates into an opening provided in the plug connector, contacting the contact element there. The contact element has a clamp-like design, and contacts the blade between the clamp-type contact parts. Pushing the blade further into the contact causes the spring-like contact parts to spread and to slide along the surface of the blade during the process of insertion. In the final position, the blade of the mating connector is usually enclosed to a large extent by the contact element of the plug connector, the actual-contact surface being between the contact parts of the contact element and of the blade.

A connecting cable is attached to the contact element, and is guided out of the housing of the plug connector by sealing elements (elastomers). A cable is also attached to the blade, which is guided out of the mating connector in the same way.

In particular when cable vibrations or other movements occur, for example micromotions or vibrating motions in motor vehicles, motions occur directly in the contact zone, i.e., between the contact parts of the contact element and the blade, which may result in friction corrosion between the contact element and the blade.

### SUMMARY OF THE INVENTION

An object of the present invention is to refine presently known plug-and-socket connections in such a way that high insertion forces are avoided, and in addition friction corrosion is prevented or at least limited, in particular in the case of vibrating motions.

The object is achieved in that the contact element has at least two contact parts in its contact zone that are positioned at a distance from each other and are provided to receive the blade; each contact part has two contact points.

According to the present invention, a plurality of contact points of the respective contact parts in an elastic arrangement are created, so as to create a redundant contact principle. Furthermore, as a result of the creation of multiple contact points in combination with additional elastic properties, self-centering of the respective blade occurs in the event of oscillating or rocking motions.

Because of the adjacent arrangement of multiple contact points in the insertion direction, lower insertion forces are needed, so that at the beginning of insertion half of the contacts contribute to the friction. This results in a gentle introduction of the respective blade into the connector.

Preferably, contact parts and contact element constitute a one-piece component. Because of the length and the material thickness of the contact part designed in this way, the rigidity of the entire contact arrangement may be adjusted and adapted to the particular surface layer.

In addition, to ensure higher contact forces, a corresponding spring may be provided.

An additional significant advantage of the present invention is the fact that due to the one-piece design the contact element is producible in a single stamping process, so that cost-effective manufacturing is possible.

Since the individual contact parts are preferably positioned at a distance from the longitudinal axis of the actual contact element, it is possible to design the width of the contact parts freely and in accordance with the particular application. As a result, wider contact points may also be created, so that currents of greater amperage may also be transmitted.

The unrestricted design of the free end of the contact element (side opposite the contact zones) leaves it up to the particular designer as to whether to provide a crimp connection or a permanent connection with the corresponding cable harness.

One particular embodiment of the present invention provides four contact parts on one contact element, clamp-like contact parts being positioned on one side or the other along the longitudinal extension of the contact element. That results in the formation of eight contact points in all, which results in very high redundancy. This design is suited for very wide blades, for example over 3 mm.

In an additional embodiment of the present invention, the actual contact element has a U-shaped design and thus has two contact legs. Located at the free ends of the respective contact legs are the contact parts, which have a wave-like design in their longitudinal extension, a contact bridge which establishes the connection between the contact part and the contact leg pointing away from the free end of the contact legs.

In the additional particular embodiment in which a total of four contact parts are provided, the contact bridge extends to both sides and has a contact part at each of its ends.

Another advantageous embodiment of the present invention may involve having the latter made in one piece.

### BRIEF DESCRIPTION OF THE DRAWINGS

FIG. 1 shows a schematic representation of the arrangement of a contact part according to the present invention in a connector housing, a mating connector being shown that establishes an electrical plug-and-socket connection with the plug connector.

FIG. 2 shows a perspective view of a first exemplary embodiment of a contact element according to the present invention.

FIG. 3 shows a perspective view of another exemplary embodiment of a contact element according to the present invention.

FIG. 4 shows a perspective view of a third exemplary embodiment of a contact element according to the present invention.

FIG. 5 shows a perspective view of a fourth exemplary embodiment of a contact element according to the present invention.

### DETAILED DESCRIPTION

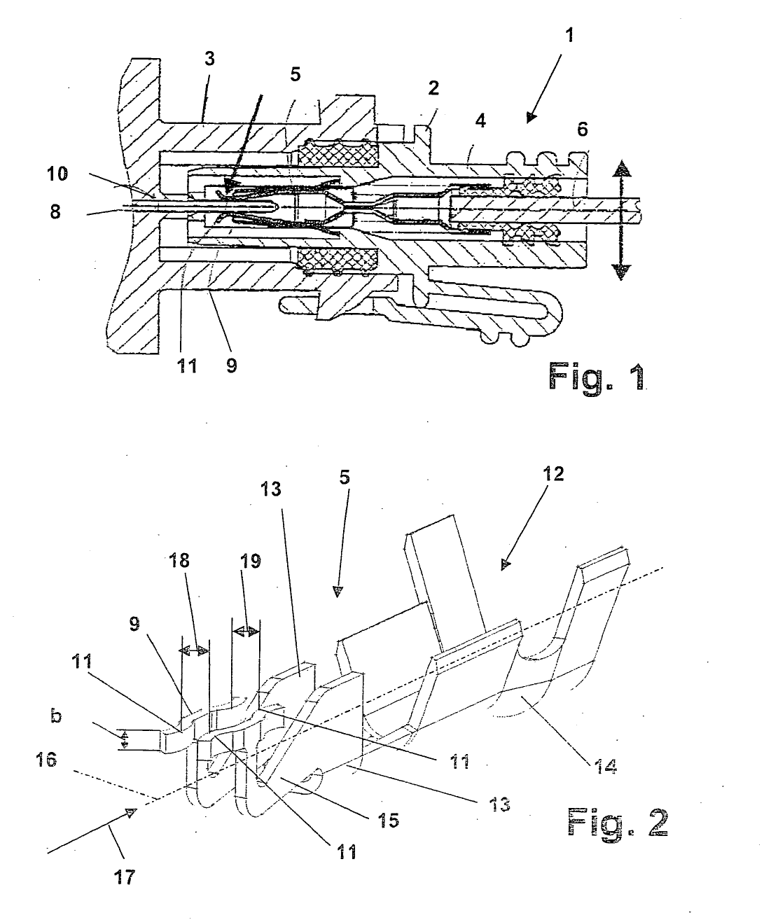

FIG. 1 shows a sectional view of electrical plug-and-socket connection 1. It includes a plug connector 2 and a mating connector 3, which are coupled together. Plug connector 2 also includes within its housing 4 a contact element 5, which is connected to a wiring harness 6. Wiring harness 6 is supported in the housing by seals 7. To establish the electrical plug-and-socket connection, mating connector 3 has a blade 8 which, in the exemplary embodiment shown in FIG. 1, is located in contact element 5 and with its surface 10 contacts contact parts 9 associated with contact element 5.

Contact parts 9 are designed in such a way that they enclose blade 8 in a clamp-like manner and have a spring-like prestress, so that the two opposing contact points 11 touch surface 10 and establish the electrical contact.

FIG. 2 shows a first exemplary embodiment of a contact element 5 according to the present invention. This contact element 5 has a U-shaped basic profile 12, basic profile 12 including contact legs 13 that have a bridge element 14 on one of their sides, and on the side opposite bridge element 14 (the free ends of contact legs 13) they exhibit contact parts 9 at least indirectly.

In the exemplary embodiment shown here, contact parts 9 are not positioned directly on contact legs 13, but rather are positioned at a distance from them via a contact bridge 15, so that contact parts 9 are positioned outside of a plane formed by longitudinal axis 16 and contact legs 13.

Contact parts 9 extend wave-like parallel to longitudinal axis 16, so that the blade is held and contacted at four contact points 11.

Contact parts 9 shown in FIG. 2 extend parallel to longitudinal axis 16, which corresponds exactly to the direction of insertion 17. In an exemplary embodiment not shown in the figures, contact parts 9 are positioned at an incline to the direction of insertion 17. This means that opposing contact parts 9, seen from the direction of insertion 17, have a different opening span 18 than the opening span 19 that is formed by the further contact point 11. This reduces the insertion forces that arise while plug connector 2 and mating connector 3 are being plugged together, so that the object of the present invention is achieved more easily.

Bridge element 14 may be designed in such a way that it connects contact legs 13 with each other directly. In the exemplary embodiment shown here in FIG. 2 it has a C-shaped design, when viewed in the direction of longitudinal axis 16. This offers the possibility that the electrical cable connecting to the contact element may be attached either by crimping or by a soldered connection.

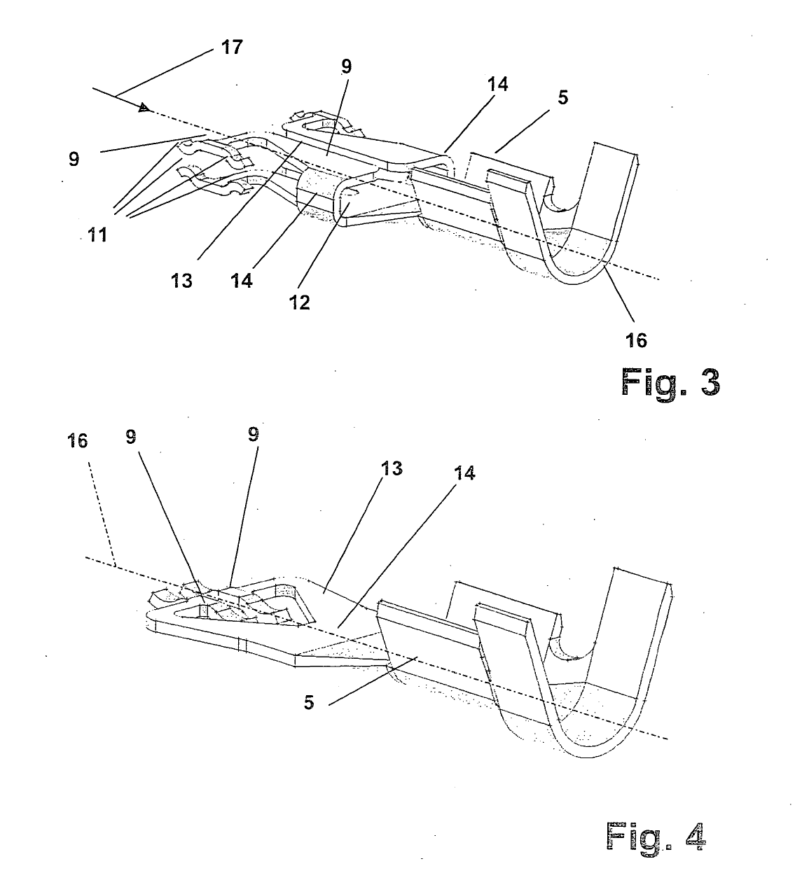

In the exemplary embodiment shown in FIG. 3, compared to FIG. 2, there are two additional clamp-like contact parts 9 provided at the ends of contact legs 13. These extend to both sides, when viewed in longitudinal direction 16, so that either two blades (not shown in the figure) may be received simultaneously by contact element 5, or one wide blade may be fixed between contact parts 9.

FIG. 4 shows an alternative version of the exemplary embodiment according to FIG. 3. It differs from the exemplary embodiment shown in FIG. 3 in the fact that only one plane of contact parts 9 is provided.

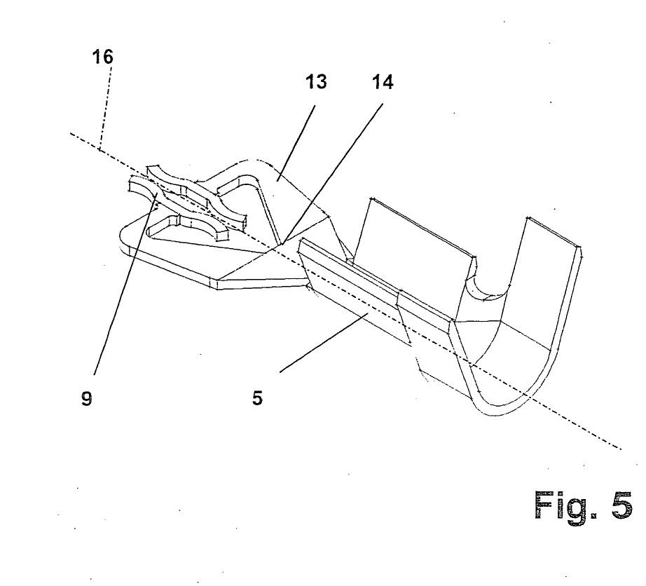

FIG. 5 shows another version of the exemplary embodiment in FIG. 4. It differs from the exemplary embodiment according to FIG. 4 in the fact that contact parts 9 are positioned displaced by 90° compared to FIG. 4.

The configuration of contact element 5 according to the present invention makes it possible to design it as a stamped and bent component, which permits cost-effective and simple manufacturing even as a mass-produced article.

1-14. (Canceled)

15. A contact element for cooperating with a plug connector, comprising:
a structure that is mountable in a connector housing and provides a contact zone to establish a disconnectable electrical connection with a mating connector having at least one blade, wherein:
the contact zone includes at least two contact parts that are positioned at a distance from each other and are provided to receive the at least one blade, and
each contact part has two contact points.

16. The contact element as recited in claim 15, wherein:
the at least two contact parts have a wave-like shape in a direction of a longitudinal axis of the contact element.

17. The contact element as recited in claim 15, wherein:
the at least two contact parts have a spoon-like shape in a direction of a longitudinal axis of the contact element.

18. The contact element as recited in claim 15, wherein:
the contact parts form a single piece with a remainder of the contact element.

19. The contact element as recited in claim 15, wherein:
at least one of the at least two contact parts includes a wider design than a width of the at least one blade to be contacted.

20. The contact element as recited in claim 15, wherein:
at least one of the at least two contact parts is positioned at a distance to a longitudinal axis of a remainder of the contact element.

21. The contact element as recited in claim 19, further comprising:
a contact bridge by which the distance is producible.

22. The contact element as recited in claim 15, further comprising:
contact legs, wherein:
the at least two contact parts include four contact parts provided at free ends of the contact legs.

23. The contact element as recited in claim 15, further comprising:
contact legs, wherein:
the at least two contact parts include eight contact parts provided at free ends of the contact legs.

24. The contact element as recited in claim 15, wherein:
the at least two contact parts are positioned parallel in a direction of a longitudinal axis of the contact element.

25. The contact element as recited in claim 15, wherein:
the at least two contact parts are positioned at a defined angle to a longitudinal axis of the contact element.

26. The contact element as recited in claim 15, wherein:
the contact element is a stamped component.

27. The contact element as recited in claim 15, wherein:
the contact element has a one-piece design.

28. The contact element as recited in claim 15, wherein:
the contact element has a two-piece design.
